(19) United States
(12) Patent Application Publication
(10) Pub. No.: US 2023/0173732 A1
(43) Pub. Date: Jun. 8, 2023

(54) SERVICE PLATFORM FOR COLLAPSING FRAME

(71) Applicant: TRANSCONTINENTAL HOLDING CORP., Chicago, IL (US)

(72) Inventors: George LIBUNAO, Chicago, IL (US); Solomon O'Neil WEST, Chicago, IL (US)

(73) Assignee: TRANSCONTINENTAL HOLDING CORP., Chicago, IL (US)

(21) Appl. No.: 18/104,166

(22) Filed: Jan. 31, 2023

Related U.S. Application Data
(63) Continuation of application No. PCT/US2021/044037, filed on Jul. 30, 2021.
(60) Provisional application No. 63/059,797, filed on Jul. 31, 2020.

(51) Int. Cl. B29C 48/265; B29C 48/27; E04G 3/28; E04G 5/14; E04G 5/00

(52) U.S. Cl. CPC B29C 48/265; B29C 48/27; E04G 3/28; E04G 5/001; E04G 5/14; E04G 5/145; B29C 48/0018

(57) ABSTRACT

Service platforms are provided for accessing the collapsing frame of blown film extrusion apparatus. The service platforms provide an access platform capable of being placed proximate the collapsing frame of the blown film extrusion apparatus to allow for service, maintenance and/or cleaning of the apparatus.

### CROSS REFERENCE TO RELATED APPLICATIONS

This application is a continuing application under 35 U.S.C. 111(a) claiming priority to International Patent Application No. PCT/US2021/044037, filed Jul. 30, 2021, which claims priority to U.S. Provisional Pat. Application No. 63/059,797, filed Jul. 31, 2020, both of which are incorporated by reference herein in their entireties.

### BACKGROUND

The present invention relates to apparatus for producing blown films by extrusion in general, and in particular, to devices, systems and methods to provide access to the collapsing frame of a blown film extrusion apparatus to help with maintenance and operation of the extrusion apparatus.

### SUMMARY

Methods, systems, and devices are described for service platforms for blown film extrusion apparatus. Service platforms according to the present disclosure may include a base platform surrounding a collapsing frame portion of the blown film extrusion apparatus on at least one or more sides. In some variations, the base platform may surround at least a portion of one, two, three, or four sides of the blown film extrusion apparatus.

The service platforms of the present disclosure further include an access platform extending from the base platform, the access platform including a frame, decking and wheels. In some service platforms of the present disclosure, the access platform may be moved along the extension tracks of the base platform between a home position distal from the collapsing frame portion of the blown film extrusion apparatus, and a range of service positions, the service positions being more proximate the collapsing frame portion of the blown film extrusion apparatus. In some variations of the service platforms of the disclosure, the access platform travels on wheels. Many variants of wheels are acceptable in the present disclosure. In some instances, the wheels may be v-grooved wheels or flat rollers. In others, the access platform may use linear bearings or a sliding tube configuration to allow the access platform to travel between home and service positions.

In some embodiments, such as those described above, the base platform may include a frame, decking, and extension tracks. In others, the base platform may include an access platform which is placed more proximate to the collapsing frame of the blown film extrusion apparatus by tilting or cantilevering platform.

In some embodiments of the service platforms which utilize wheels, the wheels may travel along a surface of the base platform. In others, the service platform may include tracks on the base platform on which the wheels travel. Such tracks, or extension tracks, may include a wide variety of known tracks, including flat tracks, v-shaped tracks, etc. In some configurations, linear bearing tracks may be used, or bearing systems may be used in which the access platform travels on tubular- or flat-bars or pipes.

In some embodiments, the service platform may include a variety of user safety and access features. In some such, the base platform may further include at least one segment of handrail, and in others multiple segments of handrails may be used. In some instances, these handrails may at least substantially surround the entire base platform. Handrails may also be provided on one or more sides or sections of the access platform. Similarly, the base and/or access platforms may include kick plates. The service platforms may further include points at which to secure a harness, or “tie-ins,” to allow a worker to secure themselves to the service platform, such as with a harness.

The service platforms taught herein may further be provided with additional features to provide accurate, safe and convenient access to the collapsing frame of the blown film extrusion apparatus. In some such systems, the base and/or access platforms may include one or more of a motorized drive, pneumatic drive, manual crank, gear drive, chain drive or a manual slide and related power and control systems to extend and/or retract the access platform. Controls for such drive systems, if needed, may be located to be accessible to a user. In some instances, such controls may be located on the base and/or or access platforms to allow safe and controlled user access. In some platforms of the disclosure, an interlock is provided with the blown film extrusion apparatus to prevent operation of the blown film extrusion apparatus when the access platform of the service platform is not in its home position.

Still other variants include service platforms which are supported in a variety of ways. In some, the service platform is supported from below; in others, the service platform is mounted to walls proximate the blown film extrusion apparatus; and in others, the service platform is suspended from above about the blown film extrusion apparatus. Such service platform supports may support the service platform in a static manner, i.e., such that the platform is held in a single position. Others may allow the service platform, or portions of the service platform, to be raised, lowered, pivoted, inclined, and/or cantilevered to allow access to the collapsing frame of the blown film apparatus. In some instances, such movable service platform supports may allow access to multiple set locations, or to a range of locations on the collapsing frame of the blown film extrusion apparatus. In some embodiments, the service platform may be provided with multiple levels, each with at least one access platform to allow service access to different areas of the collapsing frame. In others, multiple access platforms may be provided on a single level, or on multiple levels, of the service platform, to allow access to different aspects of the collapsing frame of the blown film extrusion apparatus.

In other aspects, the disclosed service platform for a blown film extrusion apparatus may be raised and/or lowered as a whole, or portions of the service platform, such as, but not limited to, the base platform and/or the access platform, may be inclined, rotated, tilted, or cantilevered together and/or independently to allow access to different portions of the collapsing frame portion of the blown film extrusion apparatus. Providing access to the collapsing frame portion of the blown film extrusion apparatus may facilitate maintenance, service, monitoring, etc., of the apparatus.

In still other variations of the service platform for a blown film extrusion apparatus of the present disclosure, a service platform for a blown film extrusion apparatus is provided which includes a base platform substantially surrounding a collapsing frame portion of the blown film extrusion apparatus on at least one side. In some versions, the service platform surrounds at least two sides of the collapsing frame portion of the blown film extrusion apparatus. In others, the service platform surrounds at least three sides of the blown film extrusion apparatus. In others, the service platform surrounds up to four sides of the collapsing frame of the blown film extrusion apparatus, while in others, the service platform completely surrounds the collapsing frame of the blown film extrusion apparatus.

In these, the base platform may be built of a frame, decking, and v-shaped extension tracks. The service platform has an access platform extending from the base platform, the access platform comprising a frame, decking and v-grooved wheels, the wheels being enclosed in a shaft such that the access platform may be moved along the extension tracks of the base platform on the wheels between a home position distal from the collapsing frame portion of the blown film extrusion apparatus, and a range of service positions, the service positions being more proximate the collapsing frame portion of the blown film extrusion apparatus.

In some variants, the service platform also includes any one or more safety features which may be placed on either or both the base platform and the access platform, including, without limitation, a handrail. Similarly, the base and/or access platforms may include kick plates. The service platforms may further include tie-ins, to allow a worker to secure themselves to the service platform.

Other features may be provided to facilitate operation of the service platform. In some versions, one of the base platform or the access platform includes a motorized drive to extend and/or retract the access platform, and a controller to control the motorized drive. In others, the controller may be remote, wireless, or accessible through a computer or smartphone. In some such platforms, an interlock is provided with the blown film extrusion apparatus to prevent operation of the blown film extrusion apparatus when the access platform of the service platform is not in its home position. Alternatively, the interlock may prevent operation of the service platform and/or of the access platform while the blown film extrusion apparatus is in operation. In others, the interlock may require further verification to allow operation of either the blown film extrusion apparatus or of the service platform while the other is operating.

Still other variants of the present disclosure include service platforms which are supported in a variety of ways. In some, the service platform is supported from below; in others, the service platform is mounted to walls proximate the blown film extrusion apparatus; and in others, the service platform is suspended from above about the blown film extrusion apparatus. Such service platform supports may support the service platform in a static manner, i.e., such that the platform is held in a single position. Others may allow the service platform, or portions of the service platform, to be raised, lowered, pivoted, inclined, and/or cantilevered to allow access to the collapsing frame of the blown film apparatus. In some instances, such movable service platform supports may allow access to multiple set locations with respect to the blown film apparatus, or with respect to the collapsing frame of the blown film apparatus. In others, the movable service platform supports may allow access to a range of locations with respect to the blown film apparatus, or with respect to the collapsing frame of the blown film apparatus. In some embodiments, the service platform may be provided with multiple levels. In some of these, the service platform may have at least one access platform on each level to allow access to different areas of the collapsing frame. In others, multiple access platforms may be provided on a single level, or on multiple levels, of the service platform, to allow access to different aspects of the collapsing frame of the blown film extrusion apparatus.

In some specific embodiments, this disclosure provides a blown film extrusion system with a collapsing frame portion and at least one service platform. In these, the service platform has a base platform which surrounds at least a portion of the collapsing frame portion of the blown film extrusion apparatus, or surrounds at least one side, at least two sides, at least three sides, substantially surrounds, or completely surrounds the collapsing frame of the blown film extrusion apparatus. This base platform has a frame, decking, and an access platform extending from the base platform. In some embodiments, the base platform includes v-shaped extension tracks, and the access platform travels on the tracks. In some such embodiments, the access platform includes a frame, decking and v-grooved wheels, with wheels enclosed in a shaft. In these embodiments, the access platform may be moved along the extension tracks of the base platform on the wheels between a home position distal from the collapsing frame portion of the blown film extrusion apparatus, and either several pre-set positions, or along a range of service positions, the service positions being more proximate the collapsing frame portion of the blown film extrusion apparatus.

In some embodiments, the blown film extrusion systems provided herein may further include a means for moving the access platform relative to the base platform, and/or means for moving portions or all of the service platform. Systems may be provided to move the entire service platform, and/or to move sections such as, without limitation, the base platform and/or the access platform together or independently. In some versions, this may include at least one motorized drive, or a hydraulic system, to extend and/or retract the access platform. The means may be placed on at least one of the base platform or the access platform. A controller may be provided to control the motorized drive and/or the positioning of the service platform.

Still other variants include service platforms which are supported in a variety of ways. In some, the service platform is supported from below; in others, the service platform is mounted to walls proximate the blown film extrusion apparatus; and in others, the service platform is suspended from above about the blown film extrusion apparatus. Such service platform supports may support the service platform in a static manner, i.e., such that the platform is held in a single position. Others may allow the service platform, or portions of the service platform, to be raised, lowered, pivoted, inclined, and/or cantilevered to allow access to the collapsing frame of the blown film apparatus. In some instances, such movable service platform supports may allow access to multiple set locations, or to a range of locations on the collapsing frame of the blown film extrusion apparatus. In some embodiments, the service platform may be provided with multiple levels and at least one access platform to allow service access to different areas of the collapsing frame. In others, multiple access platforms may be provided on a single level, or on multiple levels, of the service platform, to allow access to different aspects of the collapsing frame of the blown film extrusion apparatus.

In some specific embodiments, the service platform or system may be suspended from above, such as suspended with cables, to allow the service platform or system to be moved up or down to adjust or control proximity to the collapsing frame of the blown film extrusion apparatus. In others, the service platform or system may be suspended by vertical support that is mounted to a horizontal railing to allow the service platform to be moved by motorized means such as pneumatic, hydraulic or mechanical systems.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a perspective view of a service platform of the present disclosure, shown in place around a collapsing frame of a blown film extrusion apparatus;

FIG. 2 is a partial side plan view of a service platform of the present disclosure according to various embodiments of the invention;

FIG. 3 is a perspective view of a service platform of the present disclosure, shown in place around a collapsing frame of a blown film extrusion apparatus and a detail view of the access platform of the service platform.

FIG. 4A is a front view of the access platform of a service platform of the present disclosure.

FIG. 4B is a bottom view of the access platform of a service platform of the present disclosure.

FIG. 5A is a perspective view of the access platform of a service platform of the present disclosure.

FIG. 5B is a bottom view of the access platform of a service platform according to various embodiments of the invention.

### DETAILED DESCRIPTION OF THE INVENTION

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that any methods described may be performed in an order different than that described, and that various steps may be added, omitted or combined. Also, aspects and elements described with respect to certain embodiments may be combined in various other embodiments. It should also be appreciated that the following systems, methods, and devices may individually or collectively be components of a larger system, wherein other procedures may take precedence over or otherwise modify their application.

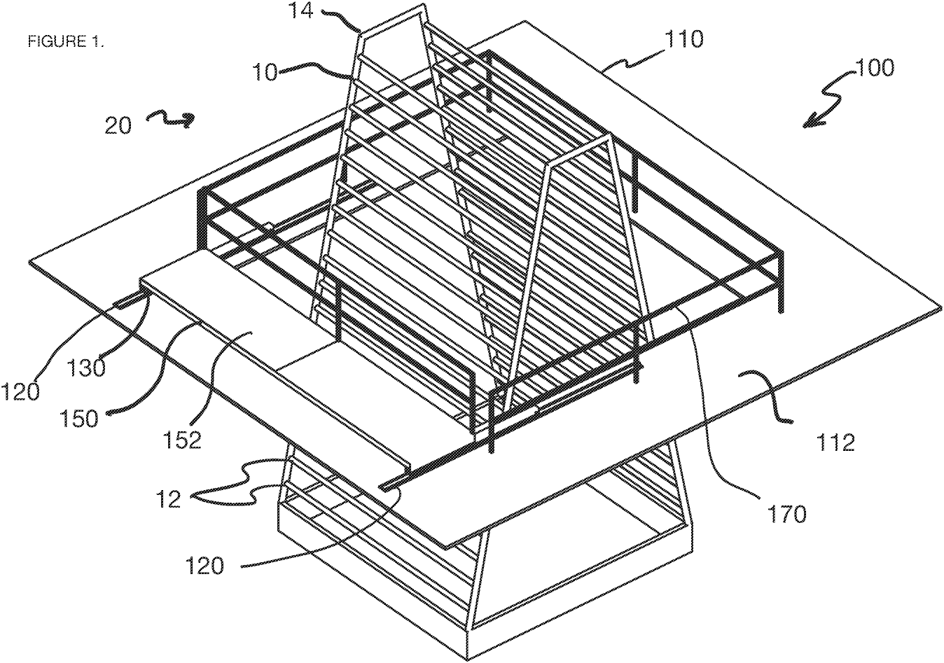

FIG. 1 is a perspective view of a service platform 100 of the present disclosure, shown in place around a collapsing frame 10 of a blown film extrusion apparatus 20. The collapsing frame 10 may include at least one, and in most systems, a plurality of rollers 12 mounted to a frame 10. The frame 10 and/or rollers 12 may require service periodically, requiring them to be accessible to a worker. The service platform 100 provided by this disclosure is shown to at least partially, and as illustrated, fully surround the collapsing frame 10 with a base platform 110. The service platform 100 further includes an access platform 150 capable of extending from the base platform 110 toward the collapsing frame 10.

In some embodiments the base platform 110 may include a frame (not illustrated) and decking 112 to support workers. The base platform 110 is illustrated in FIG. 1 to fully surround the collapsing frame 10, but it is contemplated that suitable service platforms of the present invention may optionally only partially surround the collapsing frame 10. Indeed, in some, the service platform 100 may only at least partially surround 1, 2, 3 or 4 sides of the collapsing frame 10.

The base platform 110 further includes an access platform 150 configured to place a worker in position to do work on the collapsing frame 10. The access platform 150 is attached to the base platform 110 in such a manner to allow it to slide, pivot, lower, raise, or otherwise be moved from a first or home position to at least one service position nearer the collapsing frame 10.

In some instances, the access platform 150 may include a frame, decking 152 and wheels 130. The wheels 130 may travel on the decking 112 of the base platform 110. Alternatively, in some service platforms 100 of the present disclosure, the wheels 130 of the access platform 150 may be moved along a set of extension tracks 120 positioned on the base platform 110 between a home position distal from the collapsing frame portion 10 of the blown film extrusion apparatus 20, and at least one service position. Such service positions are more proximate the collapsing frame portion 10 of the blown film extrusion apparatus 20 to allow a worker to access and service the collapsing frame 10.

Many means may be substituted for the wheels 130 discussed above. In some service platforms 100 of this disclosure, the wheels used may be v-grooved wheels or flat rollers. In others, the access platform 150 may use linear bearings or a sliding tube configuration in place of or in addition to wheels 130 to allow the access platform 150 to travel between home and service positions.

Still other means may be used to move the access platform 150 between its home and service positions. In some embodiments, the access platform 150 may be moved proximate to the collapsing frame 10 of the blown film extrusion apparatus 20 by tilting or cantilevering the access platform 150.

In embodiments of the service platforms 100 which utilize wheels 130, the wheels 130 may travel along a surface (such as decking 112 of the base platform 110. In others, the service platform 100 may include tracks 120 on the base platform 110 to direct or support wheels 130. Such tracks 120, or extension tracks, may include a wide variety of known tracks, including flat tracks, v-shaped tracks, etc. In some configurations, linear bearing tracks may be used, or bearing systems may be used in which the access platform travels on tubular- or flat-bars or pipes.

The service platforms 100 of the present invention may further include a wide variety of user safety and access features. As illustrate in FIG. 1, in some such service platforms 110, the base platform 110 may further include at least one segment of handrail 170, and in others multiple segments of handrails may be used (as illustrated in FIG. 1). In some instances, these handrails 170 may at least substantially surround the entire base platform 110. Handrails 170 may also be provided on one or more sides or sections of the access platform 150 and may alternatively be placed along outside edges of the base 110 and access platforms 150 (not shown). Other safety and access features such as kick plates (not shown), and/or harness connection points/ “tie-ins” may also be included to allow a worker using the service platform 100 to secure themselves to the service platform 100, such as with a harness.

The service platforms 100 provided may further be built to give safe and convenient access to the collapsing frame 10 of the blown film extrusion apparatus 20. To ease use, the base platform 110 and/or access platform 150 may include one or more of a motorized drive, a pneumatic drive, a manual crank, a gear drive, a chain drive or a manual slide. As needed, related power and/or control systems may be included to help a user use those drive systems to extend and/or retract the access platform 150. Controls for such drive systems, if needed, may be located to be accessible to a user, such as on the base platform 110, access platform 150, handrail 170, or elsewhere. In some platforms 100 of the disclosure, the service platform may include an interlock with the blown film extrusion apparatus 20 preventing operation of the blown film extrusion apparatus 20 when the access platform 150 of the service platform 100 is not in its home position.

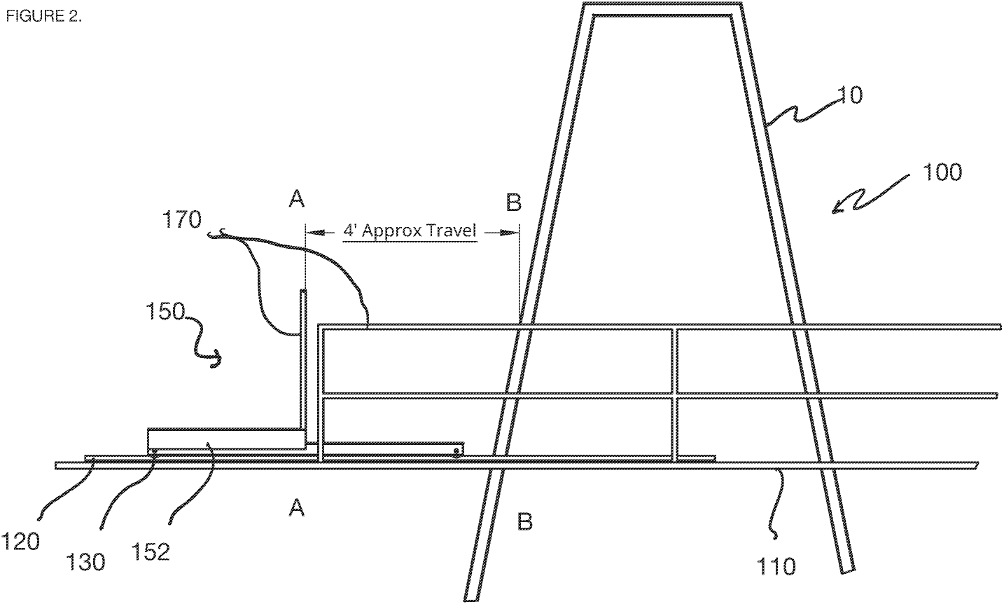

FIG. 2 is a partial side plan view of a service platform 100 of the present disclosure. The service platform 100 is shown in relation to the collapsing frame 10 of a blown film apparatus. The base platform 110 is shown to support an access platform 150 with decking 152 and handrails 170. As illustrated, the access platform 150 travels along tracks 120 using wheels 130. The access platform 150 is shown to have a home position A, and a service position B. Without limitation, these positions are shown in FIG. 2 to be approximately 4 feet apart. In other embodiments, the travel, or distance between these positions varies by the size of the service platform 110 and its placement relative to the collapsing frame 10. Further, in some embodiments, a range of positions B may be provided to place the access platform 150 nearer to the collapsing frame 10.

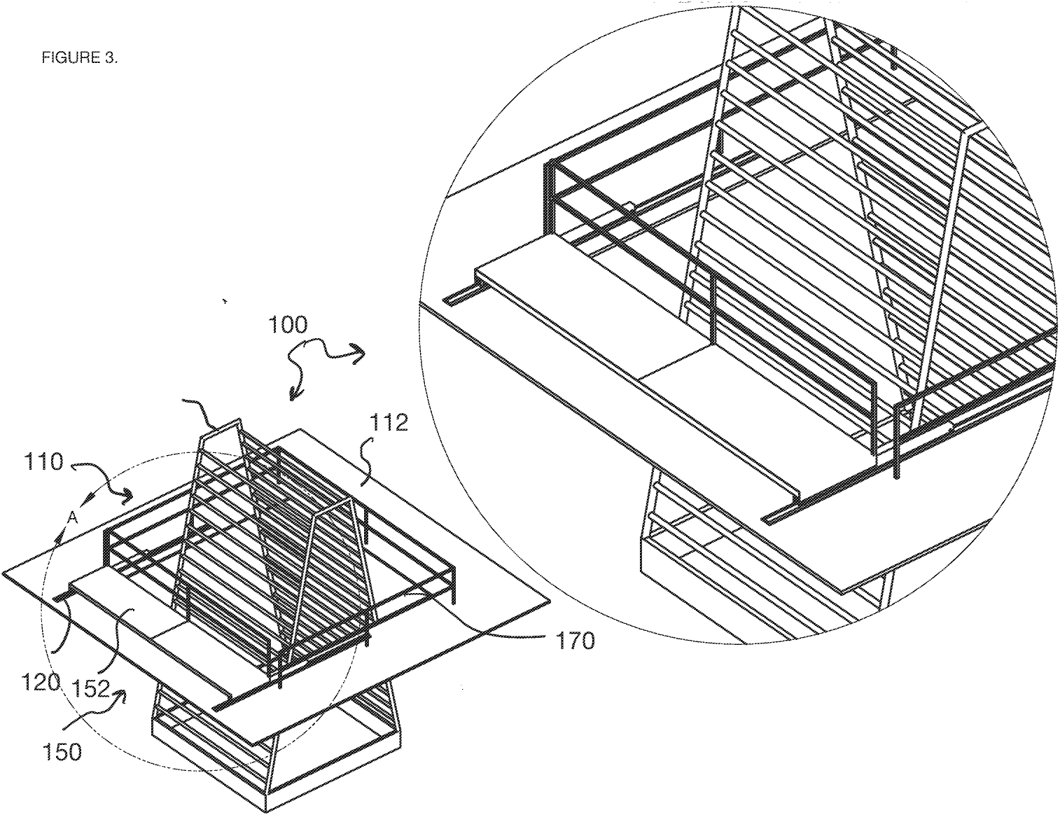

FIG. 3 provides a perspective view of a service platform 100 of the present disclosure, shown in place around a collapsing frame 10 of a blown film extrusion apparatus 20. FIG. 3 further provides a detail view of the access platform 150 of the service platform 100. FIG. 3 further illustrates the relationship between the access platform 150 and the base platform 110. In this embodiment, the base platform 110 includes rails 120 on which the wheels of the service platform 150 travel to extend the service platform 150 during use.

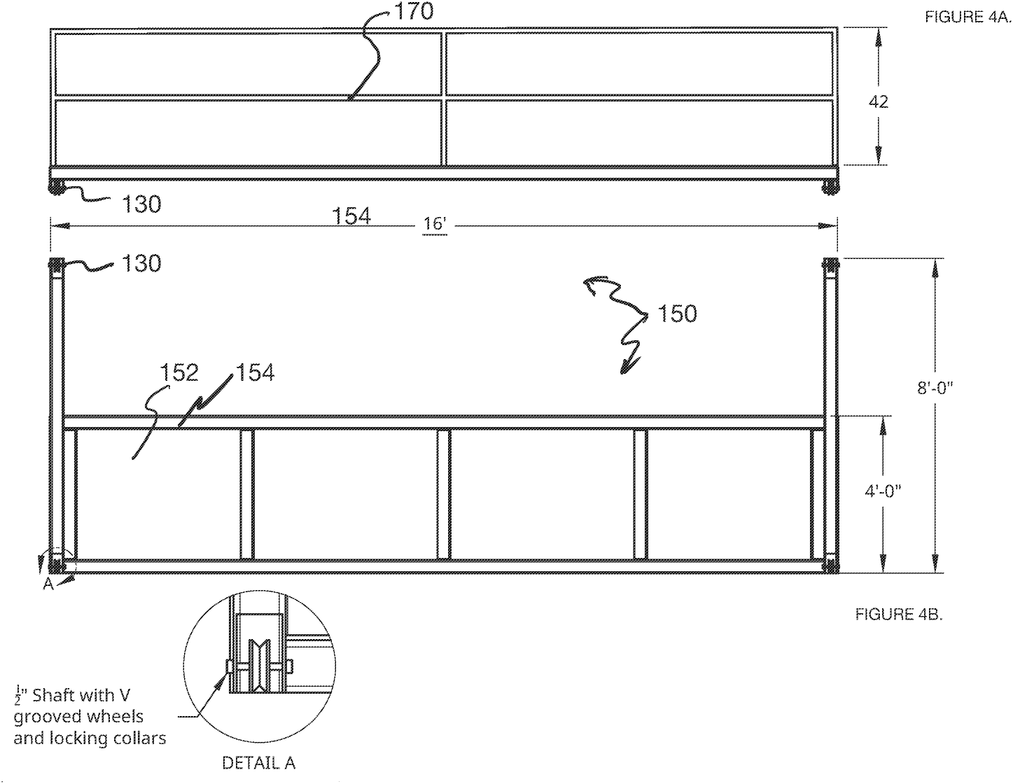

FIG. 4A is a front view of the access platform 150 of a service platform 100 according to the present invention. The access platform 150 is here shown to include a handrail 170. A frame 154 supports the handrail 170 and wheels 130. FIG. 4B provides a bottom view of the access platform 150 of FIG. 4A. In FIG. 4B, an exemplary frame 154 is illustrated, spanned by decking 152. In this exemplary configuration, the frame 154 includes wheels 130.

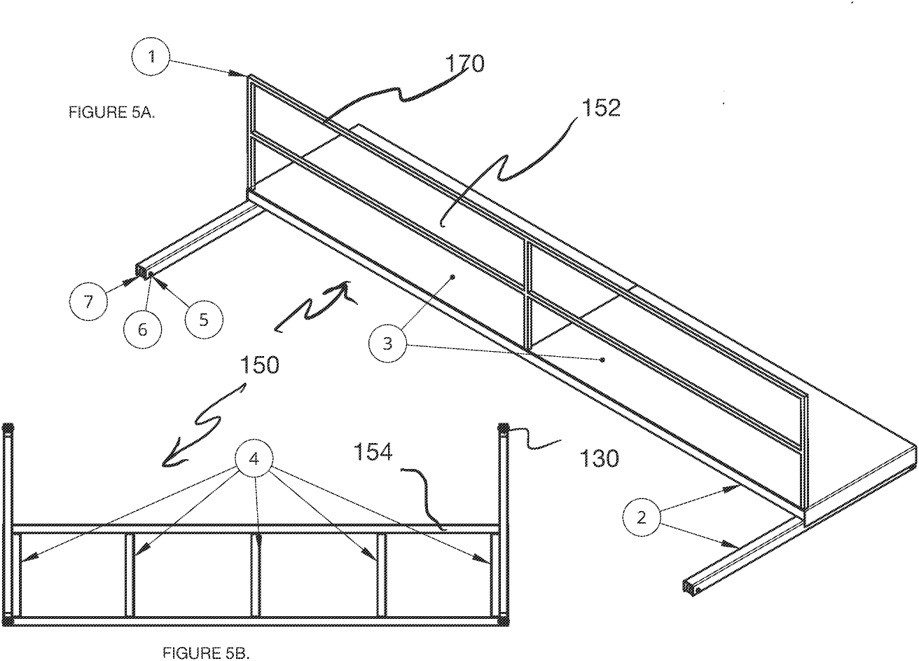

FIG. 5A is a perspective view of the access platform 150 of a service platform 100 of the present disclosure. FIG. 5B provides a bottom view of the access platform 150 of FIG. 5A.

The indicated dimensions of the embodiments illustrated in FIGS. 1 through 5B and each embodiment discussed herein are exemplary and non-limiting, as the structures of the present invention may be adapted to fit a range of sizes and shapes of collapsing frames 10 without altering the invention of the present disclosure.

The service platforms 100 of the present disclosure may be supported in a variety of ways. In some, the service platform 100 may be supported on fixed-height posts positioned below the platform 100. In others, the service platform 110 may be supported on lifting mechanisms to raise and lower the platform 100 to a variety of heights along the collapsing frame 10 to allow the access platform 150 to be placed at various positions along the collapsing frame 10 to facilitate access and service. In these embodiments, controllers may be mounted to the service platform 100 to allow control the height of the platform during use. In other versions, the controller may be mounted remotely to allow height adjustment by others or before or after use of the service platform 100.

In other configurations, the service platform 100 may instead be mounted to walls adjacent to the blown film extrusion apparatus 20, freeing the floor of support posts. In still others, the service platform 100 may be suspended from above about the collapsing frame 10 of the blown film extrusion apparatus 20. Such service platform supports may support the service platform 100 in a static manner, i.e., such that the platform 100 is held in a single position. Others may allow the service platform, or portions of the service platform, to be raised, lowered, pivoted, inclined, and/or cantilevered to allow access to the collapsing frame of the blown film apparatus. In some instances, such movable service platform supports may allow access to multiple set locations, or to a range of locations on the collapsing frame 10 of the blown film extrusion apparatus 20. In some embodiments, the service platform 100 may include multiple base platforms 110 at a variety of locations, positions or levels, each with at least one access platform 150 to allow service access to different areas of the collapsing frame 10. In others, multiple access platforms 150 may be provided on a single level, or on multiple levels, of the service platform, to allow access to different aspects of the collapsing frame 10 of the blown film extrusion apparatus 20.

In other variations of the service platforms 100 of the present invention, the service platform 100 may be raised and/or lowered as a whole, or portions of the service platform 100, such as, but not limited to, the base platform 110 and/or the access platform 150, may be inclined, rotated, tilted, or cantilevered together and/or independently to allow access to different portions of the collapsing frame portion 10 of the blown film extrusion apparatus 20.

The methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, several steps may be undertaken before, during, or after the above elements are considered. Accordingly, the above description should not be taken as limiting the scope of the invention.

What is claimed is:

1. A service platform for a blown film extrusion apparatus, the service platform having:
a base platform substantially surrounding a collapsing frame portion of the blown film extrusion apparatus on at least one, and up to four side(s) of the blown film extrusion apparatus, the base platform comprising a frame, decking, and extension tracks or a tilting and/or cantilevered platform;
an access platform extending from the base platform, the access platform comprising a frame, decking and wheels, wherein the access platform may be moved along the extension tracks of the base platform on the wheels between a home position distal from the collapsing frame portion of the blown film extrusion apparatus, and a range of service positions, the service positions being more proximate the collapsing frame portion of the blown film extrusion apparatus.

2. The service platform for a blown film extrusion apparatus of claim 1, wherein the extension tracks of the base platform are v-shaped, linear bearing, tube- or flat-bars, and/or pipes.

3. The service platform for a blown film extrusion apparatus of claim 1, wherein the wheels of the access platform are v-grooved, flat rollers, linear bearing, and/or sliding tube configurations.

4. The service platform for a blown film extrusion apparatus of claim 1, wherein the base platform further includes a handrail and/or a kick plate and/or a harness tie-in.

5. The service platform for a blown film extrusion apparatus of claim 1, wherein the access platform further includes a handrail.

6. The service platform for a blown film extrusion apparatus of claim 1, wherein one of the base platform or the access platform includes a motorized drive, a pneumatic drive, a manual crank, a gear drive, a chain drive and/or a manual slide to extend and/or retract the access platform.

7. The service platform for a blown film extrusion apparatus of claim 6, further including a controller.

8. The service platform for a blown film extrusion apparatus of claim 1, further comprising a service platform support.

9. The service platform for a blown film extrusion apparatus of claim 8, wherein the service platform support may be raised and/or lowered, tilted, inclined and/or cantilevered to allow access to different portions of the collapsing frame portion of the blown film extrusion apparatus.

10. The service platform for a blown film extrusion apparatus of claim 1, further comprising an interlock with the blown film extrusion apparatus to prevent operation of the blown film extrusion apparatus when the access platform is not in the home position.

11. A service platform for a blown film extrusion apparatus, the service platform having:
a base platform substantially surrounding a collapsing frame portion of the blown film extrusion apparatus on at least one and up to four sides of the collapsing frame of the blown film extrusion apparatus, the base platform comprising a frame, decking, and v-shaped extension tracks;
at least one access platform extending from the base platform, the access platform comprising a frame, decking and v-grooved wheels, the wheels being enclosed in a shaft;
wherein the access platform may be moved along the extension tracks of the base platform on the wheels between a home position distal from the collapsing frame portion of the blown film extrusion apparatus, and a range of service positions, the service positions being more proximate the collapsing frame portion of the blown film extrusion apparatus.

12. The service platform for a blown film extrusion apparatus of claim 11, wherein the base platform further includes a handrail.

13. The service platform for a blown film extrusion apparatus of claim 11, wherein the access platform further includes a handrail.

14. The service platform for a blown film extrusion apparatus of claim 11, wherein one of the base platform or the access platform includes a motorized drive to extend and/or retract the access platform, and a controller to control the motorized drive.

15. The service platform for a blown film extrusion apparatus of claim 11, further comprising a service platform support.

16. The service platform for a blown film extrusion apparatus of claim 15, wherein the service platform support may be raised and/or lowered, pivoted, inclined, tilted and/or cantilevered to allow access to different portions of the collapsing frame portion of the blown film extrusion apparatus.

17. The service platform for a blown film extrusion apparatus of claim 11, further comprising an interlock with the blown film extrusion apparatus to prevent operation of the blown film extrusion apparatus when the access platform is not in the home position.

18. A blown film extrusion system, the system comprising:
a collapsing frame portion; and
at least one service platform, the service platform including a base platform substantially surrounding the collapsing frame portion of the blown film extrusion apparatus on at least three sides of the blown film extrusion apparatus, the base platform comprising a frame, decking, and v-shaped extension tracks; and an access platform extending from the base platform, the service platform comprising a frame, decking and v-grooved wheels, the wheels being enclosed in a shaft;
wherein the access platform may be moved along the extension tracks of the base platform on the wheels between a home position distal from the collapsing frame portion of the blown film extrusion apparatus, and a range of service positions, the service positions being more proximate the collapsing frame portion of the blown film extrusion apparatus.

19. The blown film extrusion system of claim 18, wherein one of the base platform or the access platform includes a motorized drive to extend and/or retract the service platform, and a controller to control the motorized drive.

20. The blown film extrusion system of claim 19, further comprising a service platform support which may be raised and/or lowered to allow access to different portions of the collapsing frame portion of the blown film extrusion apparatus.
